(19) United States
(12) Patent Application Publication
(10) Pub. No.: US 2015/0073940 A1
(43) Pub. Date: Mar. 12, 2015

(54) SYSTEM AND METHOD FOR ONLINE SHOPPING FROM SOCIAL MEDIA AND DO-IT-YOURSELF (DIY) VIDEO FILES

(71) Applicants: Geun Sik Jo, (US); Inha Industry Partnership Institute, Incheon (KR)

(72) Inventor: Geun Sik Jo, Incheon (KR)

(73) Assignees: INHA INDUSTRY PARTNERSHIP INSTITUTE, Incheon (KR); Geun Sik Jo, Incheon (KR)

(21) Appl. No.: 14/182,591

(22) Filed: Feb. 18, 2014

(30) Foreign Application Priority Data
Sep. 9, 2013 (KR) 10-2013-0107661

(51) Int. Cl. G06Q 30/06

(52) U.S. Cl. CPC G06Q 30/0625
USPC 705/26.62

(57) ABSTRACT

Embodiments of the present invention provide an online shopping system related to a Do-It-Yourself (DIY) project. Metadata is overlaid or embedded in an interactive DIY video file which may be viewed from a social media website. The metadata includes information associated with a set of materials used in the DIY video. A user registers the DIY video file a user web page and the DIY video is played from the user web page. The materials information is extracted from the metadata and displayed on the screen. The system connects to any number of online shopping malls where the DIY materials may be purchased.

### CROSS-REFERENCE TO RELATED APPLICATION

This application claims the priority benefit of Korean Patent Application No. 10-2013-0107661, filed on Sep. 9, 2013, in the Korean Intellectual Property Office, the disclosure of which is incorporated herein by reference.

### TECHNICAL FIELD

Embodiments of the present invention relate generally to video files. Specifically, the present invention relates to attaching metadata content to objects in Do-It-Yourself (DIY) video files.

### BACKGROUND

Do-It-Yourself (DIY) is the method of building, modifying, or repairing something without the aid of experts or professionals. The term “Do-It-Yourself” has been associated with consumers since at least 1912, primarily in the domain of home improvement and maintenance activities. Since that time, the term has taken on a broader meaning that covers a wide range of skills.

In the 1970s, when home video cassette recorders (VCRs) came along, DIY instructors quickly grasped its potential for demonstrating processes by audio-visual means. In 1979, the PBS television series This Old House, starring Bob Vila, premiered and this spurred a DIY television revolution. The show was immensely popular, educating people on how to improve their living conditions (and the value of their house) without the expense of paying someone else to do (as much of) the work. In 1994, the HGTV Network cable television channel was launched in the United States and Canada, followed in 1999 by the DIY Network cable television channel. Both were launched to appeal to the growing percentage of North Americans interested in DIY topics, from home improvement to cooking and food preparation. Such channels have multiple shows showing how to stretch one's budget to achieve professional-looking results while doing the work yourself.

Beyond magazines and television, the scope of DIY continues to grow online where most mainstream media outlets now have extensive DIY-focused informational websites such as This Old House, Martha Stewart, and the DIY Network. These are often extensions of their magazine or television brand. The growth of independent online DIY resources is also increasing. Additionally, many DIY videos are viewed each day with the use of social media such as YouTube.

### SUMMARY

In general, embodiments of the present invention provide an online shopping system related to a Do-It-Yourself (DIY) project. Metadata is overlaid or embedded in an interactive DIY video file which may be viewed from a social media website. The metadata includes information associated with a set of materials used in the DIY video. A user registers the DIY video file on a user web page and the DIY video is played from the user web page. The materials information is extracted from the metadata and displayed on the screen. The system connects to any number of online shopping malls where the DIY materials may be purchased.

A first aspect of the present invention provides a method for online shopping, the method comprising the computer-implemented steps of: overlaying metadata on a Do-It-Yourself (DIY) video file, wherein the metadata includes information associated with a set of materials used in the DIY video file; registering the DIY video file with a web page; playing the DIY video file from the web page; extracting the information associated with the set of materials from the metadata when the DIY video file is played from the web page; and connecting with at least one online shopping mall, wherein each online shopping mall includes at least one material in the set of materials for purchase.

A second aspect of the present invention provides a computer-readable storage medium storing computer instructions which, when executed, enables a computer system to provide online shopping, the computer instructions comprising: overlaying metadata on a Do-It-Yourself (DIY) video file, wherein the metadata includes information associated with a set of materials used in the DIY video file; registering the DIY video file with a web page; playing the DIY video file from the web page; extracting the information associated with the set of materials from the metadata when the DIY video file is played from the web page; and connecting with at least one online shopping mall, wherein each online shopping mall includes at least one material in the set of materials for purchase.

A third aspect of the present invention provides a system for online shopping in a networked computing environment, comprising: a memory medium comprising instructions; a bus coupled to the memory medium; and a processor coupled to the bus that when executing the instructions causes the system to: overlay metadata on a Do-It-Yourself (DIY) video file, wherein the metadata includes information associated with a set of materials used in the DIY video file; register the DIY video file with a web page; play the DIY video file from the web page; extract the information associated with the set of materials from the metadata when the DIY video file is played from the web page; and connect with at least one online shopping mall, wherein each online shopping mall includes at least one material in the set of materials for purchase.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts pasta dish ingredients according to an embodiment of the present invention.

FIG. 2 depicts a system structure of an interactive video-based online shopping service according to an embodiment of the present invention.

FIG. 3 depicts shows a method flow diagram of a process for providing an interactive video-based online shopping service according to embodiments of the present invention.

FIGS. 4A-B depicts a screenshot showing the addition of annotation regarding cooking video's main ingredients according to an embodiment of the present invention.

FIG. 5 depicts the cooking video including the integrated recipe information as metadata displayed in a video player according to an embodiment of the present invention.

FIG. 6 depicts a screenshot of an example online shopping system allowing a user to replay a video in the user calendar according to an embodiment of the present invention.

FIG. 7 depicts a screenshot for selecting a particular time period for displaying a cooking list according to an embodiment of the present invention.

FIG. 8 depicts an example cooking list for a selected time period according to an embodiment of the present invention.

FIGS. 9 and 10 depict example ingredient lists for a selected time period according to an embodiment of the present invention.

FIG. 11 depicts an ordering options list for user selection according to an embodiment of the present invention.

FIG. 12 depicts a price priority option showing information collected from a number of shopping malls.

FIG. 13 depicts a block diagram of an online shipping system offering an interactive video-based online shopping service.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

While the system and method of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the process of the present application as defined by the appended claims.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

As indicated above, embodiments of the present invention provide an online shopping system related to a Do-It-Yourself (DIY) project. Metadata is overlaid or embedded in an interactive DIY video file which may be viewed from a social media website. The metadata includes information associated with a set of materials used in the DIY video. A user registers the DIY video file on a user web page and the DIY video is played from the user web page. The materials information is extracted from the metadata and displayed on the screen. The system connects to any number of online shopping malls where the DIY materials may be purchased.

It is apparent that there has been provided with this invention an approach for attaching metadata content to objects in Do-It-Yourself (DIY) video files. While the invention is particularly shown and described in conjunction with an interactive cooking video, it will be appreciated that the systems and methods described herein can be applied to any type of DIY project. The metadata of the cooking video example discussed herein includes recipe information and ingredients. The metadata for another type of DIY project may include DIY information such as instructions and/or materials. Therefore, it is to be understood that the appended claims are intended to cover all such modifications and changes that fall within the true spirit of the invention.

When chefs appear on television to explain how to prepare a particular food dish, they discuss the necessary ingredients and typically demonstrate cooking the dish using a recipe. The demonstration includes visual, auditory, and olfactory information provided either progressively or simultaneously. If it is a dish that a viewer is interested in, the viewer needs to understand the recipe instructions and ingredients. To confirm the recipe and ingredients, the user may replay the video and write down the recipe and a shopping list of the necessary ingredients for the recipe. Because the cooking video information does not contain computer readable standard information pertaining to the ingredients, viewers need to manually write down these ingredients. Usually, during the first time of watching the video, the viewer's attention is too occupied with just watching the cooking demonstration making it necessary for the viewer to write down the ingredients if the ingredients are listed at the end of the video or by replaying the video and writing down the ingredients during the cooking demonstration.

A user watching a cooking video is often primarily interested in learning how the chef prepares the particular food dish discussed in the video. A user might actually write down each ingredient and the steps of the recipe while watching the chef discuss preparation of the food dish. Alternatively, the user might write down the information during a subsequent replay of the video. Today, each ingredient in the recipe must be separately inputted in a search engine at an online shopping mall for consideration of purchase. This process, once again, proves to be very time consuming for users. Furthermore, conventional food recipes are written in terms of servings, making it even more time consuming for a user who must determine the necessary amount of the different ingredients while shopping.

In addition, when a user decides to purchase an item while watching the video, the user may not know the precise name or precise amount of a particular ingredient. Since the current online shopping environment is structured on a keyword or category basis, making an online purchase of the ingredient may be difficult or impossible.

It is reiterated that although this disclosure includes a detailed description related to cooking and food preparation, implementation of the teachings recited herein are not limited to these particular examples. Rather, the embodiments of the present invention are intended to be implemented with any video file related to any type of DIY project. For instance, an example DIY project may include home improvement or maintenance, car repair, or the like. The examples listed above are exemplary only and not intended to be limiting. Any type of DIY project may be discussed in the video file.

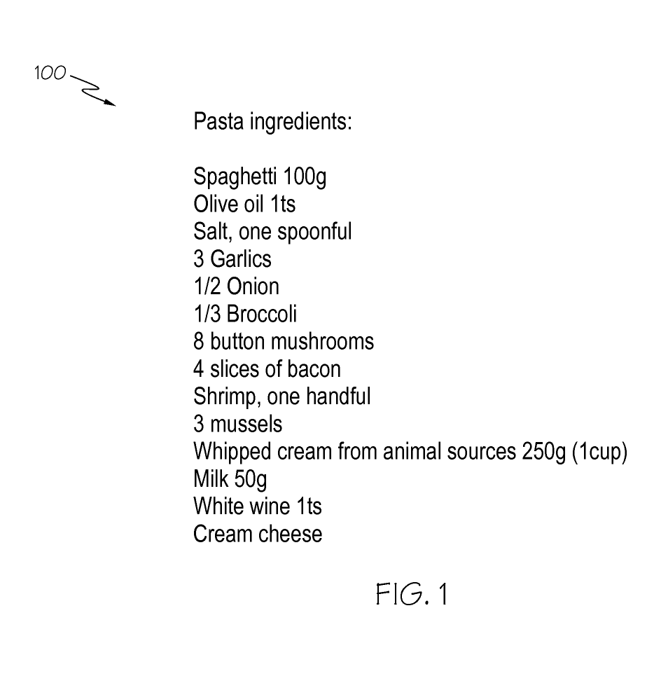

Aspects of the present invention are described below with reference to a video file describing the preparation of a pasta dish. FIG. 1 lists the ingredients necessary for making two servings of a particular pasta dish. Purchasing the ingredients in a current shopping mall environment may be very time consuming. Also, it may be difficult to calculate the amount of ingredients necessary when friends come over and required servings are suddenly increased. Recently, an increasing number of people are concerned with staying healthy. It is difficult to quickly calculate the calories associated with the ingredients. The present invention addresses this issue by offering a system and method for a user to easily make a single online purchase of the ingredients using the recipe information associated with the video.

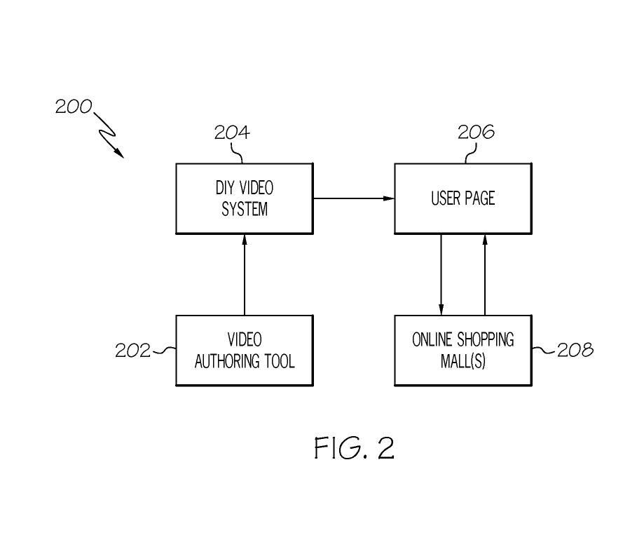

FIG. 2 depicts a system structure 200 of an interactive video-based online shopping service. Video authoring tool 202 is used to add metadata to a cooking video through annotation to generate a cooking video capable of interaction. The cooking video is provided to users through an interactive DIY video system 204. In one example, the DIY video system 204 includes one or more DIY videos which are offered to users via the DIY video system 204. While watching the cooking video, a user may add the video or image associated with the video to a web page 206 associated with the user. In one example, the web page may be a calendar. Based on the stored video or image in the user's calendar, a search of the necessary ingredients for the food described in the video may be conducted. The user may be presented with price comparisons of the various ingredients from online shopping malls 208. In one example, the online shopping system includes one or more online shopping malls. A purchase may then be made by the user from at least one of these malls.

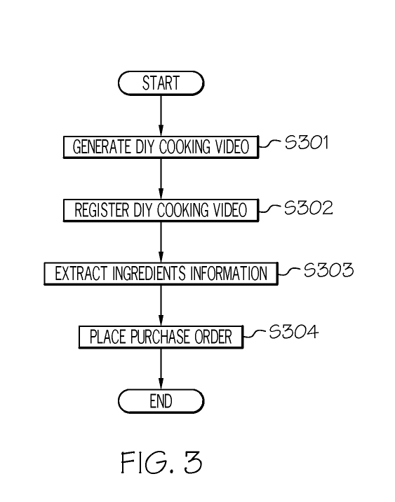

FIG. 3 depicts shows a method flow diagram of a process for providing an interactive video-based online shopping service. At step S301, an online shopping system may generate an interactive cooking video by adding recipe information from a recipe donor onto a cooking video of interest. At this time, the online shopping system can separately store and manage metadata pertaining to the video data and recipe information. The recipe information may include the name and amount of each ingredient used, cooking steps, ingredient measurement, and the like. The metadata may be stored as a single file format (e.g., eXtensible Markup Language or ‘XML’) or the details pertaining to the relevant recipe may be stored and managed in a database.

In order to provide the interactive video-based online shopping service, the interactive cooking video may be generated by various people ranging from expert chefs to average people with cooking experience. To easily generate these videos, production tools for generating an interactive cooking video are necessary. To better understand the present invention's intended purpose, the process of generating the interactive cooking video needs to be further explained. First and foremost, the interactive cooking video needs to support WYSIWYG (What You See Is What You Get) and a recipe donor must be able to easily add virtual artifacts (i.e., metadata) to the cooking video.

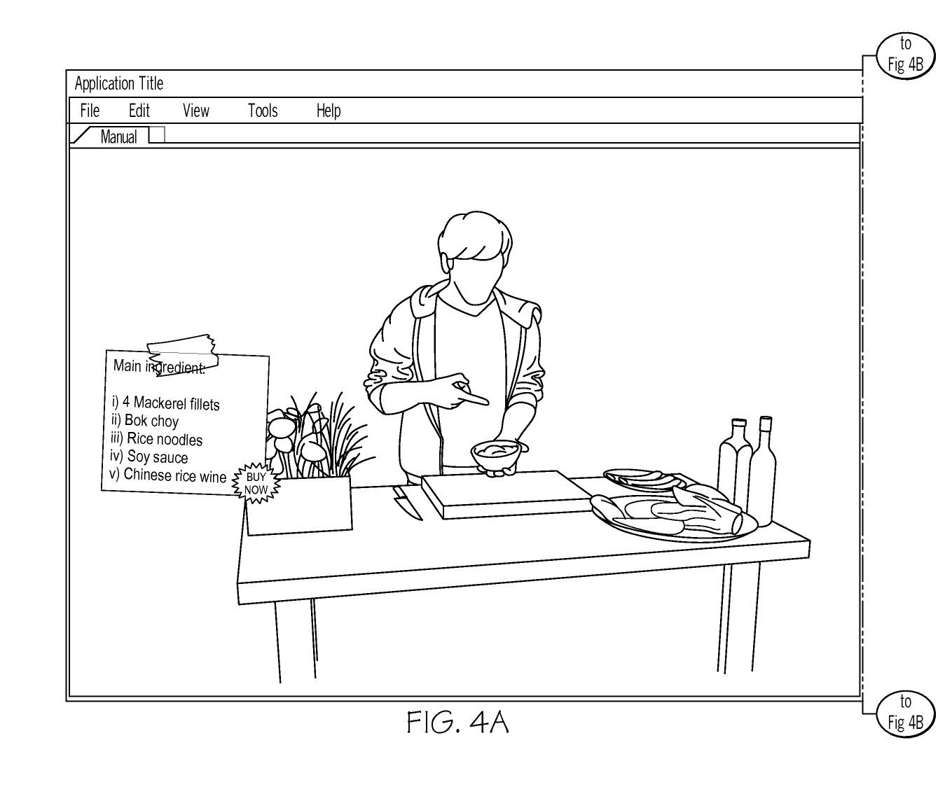

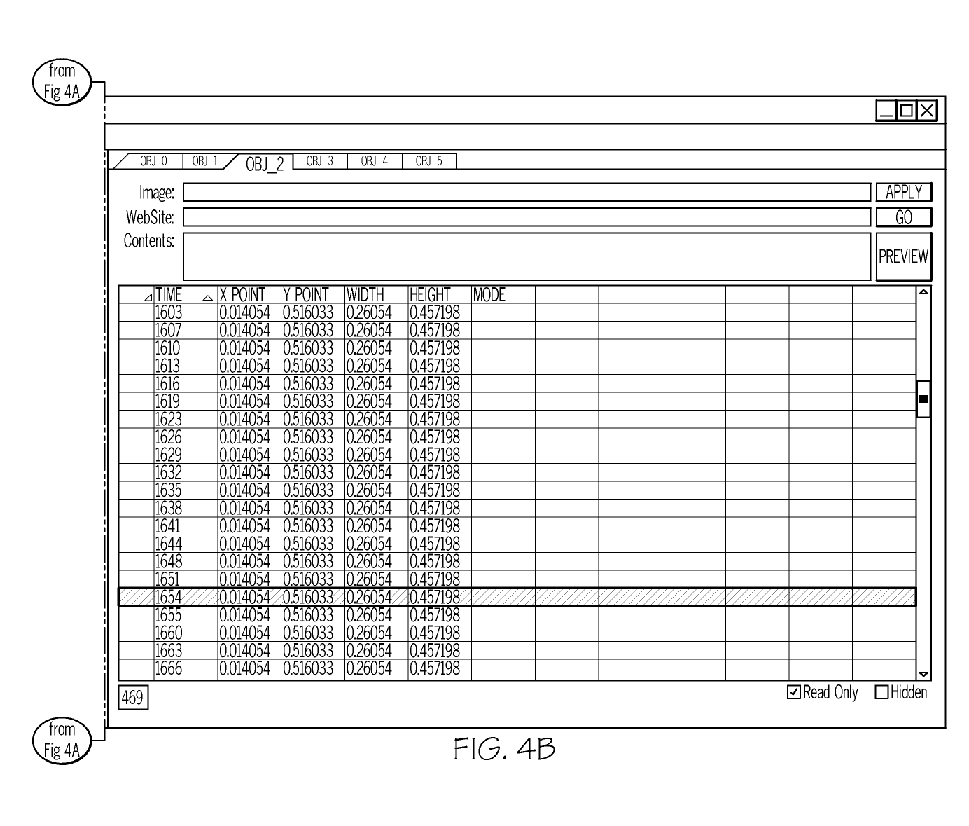

FIGS. 4A-B depicts a screenshot showing the addition of annotation regarding cooking video's main ingredients. The annotation (i.e., metadata) can be expressed in a meaningful fashion. Since the metadata is stored separately from the actual video, the structure is very flexible to allow for the exchange of information between users or systems. As such, a recipe donor may use video authoring tool 202 (shown in FIG. 2) to add the annotation to be displayed on the video at a specific frame or time. The recipe donor may generate the metadata and integrate it into the video. The cooking video including the integrated recipe information 501 as metadata may be displayed in a video player as shown in FIG. 5.

Referring back to FIG. 3, the cooking video may be registered (or linked) to a web page associated with a user at step S302. The registration process provides the user page with a frame (or series of frames) of the cooking video and a Uniform Resource Identifier (URI) of the actual cooking video. When the user wishes play the video, the URI is used to access the entire cooking video. The term “user” as used herein refers to any person wishing to interact with a particular DIY video. In one example, the web page may be a calendar with the cooking video being added to a date on the calendar specified by the user.

The online shopping system may receive an identification number (ID) associated with a user-selected interactive cooking video or relevant image. In one example, the identification number for the image's Uniform Resource Identifier (URI). The video or image associated with the identification number may be used to add the video or image to a user web page. In one example, the user web page may include a user calendar. The calendar may be divided in time sections (e.g., years, months, weeks, days) and can further be divided in terms of meals (e.g., breakfast, lunch, dinner).

A user, while watching an interactive cooking video provided by the DIY video system 204, may add the cooking video to a personal web page, such as a personal calendar menu. For example, the pasta dish may be added to a dinner section on a particular calendar date. In one example, a cooking video or image may be added to a user's personal page using an associated ID through a drag and drop method from DIY video system 204 to user page 206. In another example, the video or image may be added by other means.

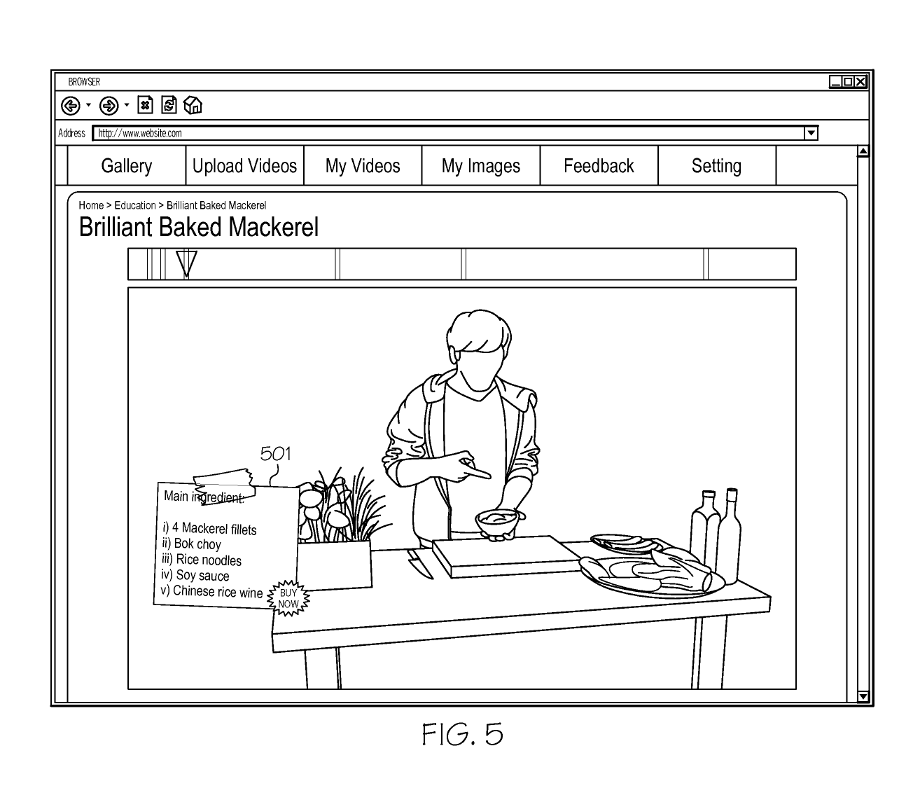

In order to prepare the particular dish shown in the cooking video, the user must acquire the needed ingredients. The online shopping system allows a user to replay a video by clicking on the video or its image in the user calendar, as shown in FIG. 6. Since the ingredients and cooking instructions are provided to a user using metadata, additional viewings of the same video to determine the necessary ingredients is no longer necessary. This also allows a user to set up a cooking schedule on a weekly, or even monthly, basis.

Again, referring back to FIG. 3, the online shopping system may receive the cooking recipe information from the video or its image in the user's calendar at step S303. From the obtained recipe information, the necessary ingredients may be extracted. The online shopping system may receive the recipe information from the video through the video's ID or the image's URI added in the user's calendar. The received recipe information may be in stored in XML format, JavaScript Object Notation (JSON) format, ontology format, string format, or the like. Using the video's ID or image's URI, the location of the recipe information may be retrieved. The online shopping system may extract the ingredient information from the received recipe information.

The online shopping system may store information about each ingredient. In one example, a name, category (e.g., main ingredient, side ingredient, common ingredient, uncommon ingredient, or the like), and ingredient amount (e.g., 2 cups, 3 teaspoons, etc.) may be stored. In another example, other information associated with an ingredient may be stored. Ingredient information may be inputted by a recipe donor. In a case where the recipe donor does not categorize each ingredient, categorization of the ingredients may be provided by other means (e.g., a Jaccard coefficient method, a domain expert, or the like).

Referring back to FIG. 3, at step S304, the online shopping system may communicate with diverse shopping malls in order to enable a user to make one or more ingredient purchases from at least one of those shopping malls in a single purchase. The cooking ingredients for the different dishes to be prepared may be stored by time sections in a user calendar. In one example, the recipe ingredients may be stored categorically (e.g., main ingredient or side ingredient) within a time section. This enables a user to easily access the cooking list, main ingredient list, and side ingredient list according to time section. As such, the online shopping system can display the main and side ingredients pertaining to a selected time section, as well as information pertaining to appropriate ingredient measurements. Moreover, the user may adjust portions/servings of a particular dish, and this information can be reflected through measurements of both main and side ingredients in real-time. Ingredients determined to no longer be needed may also be removed.

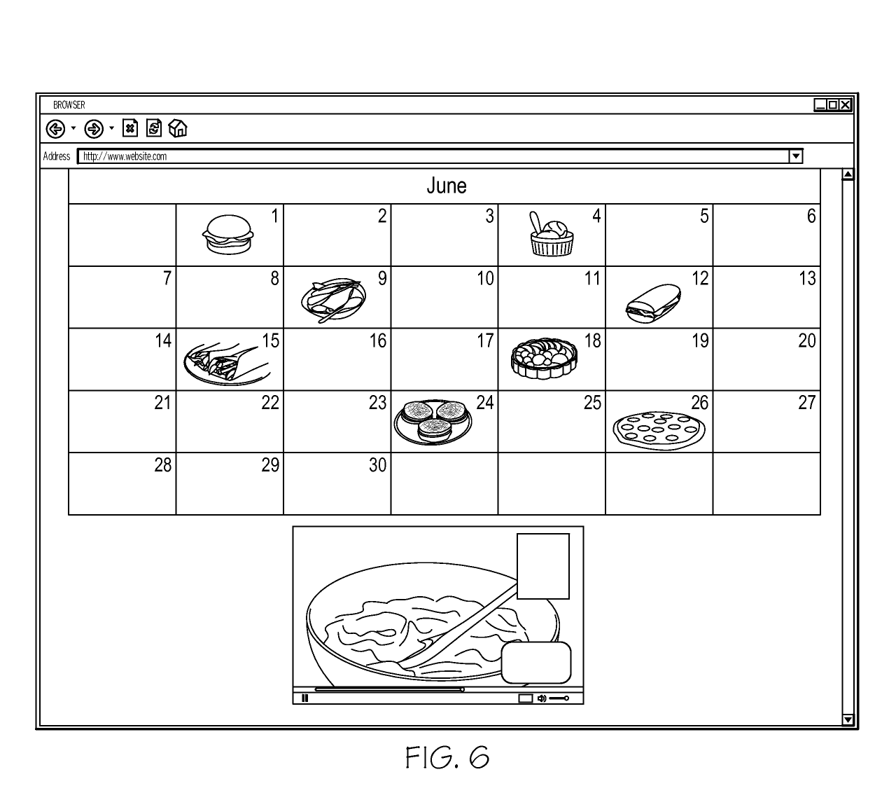

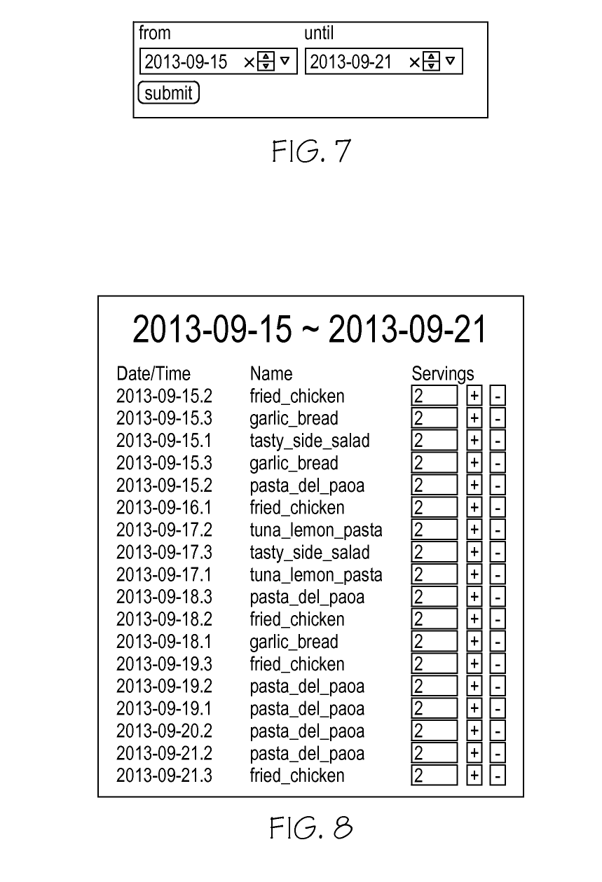

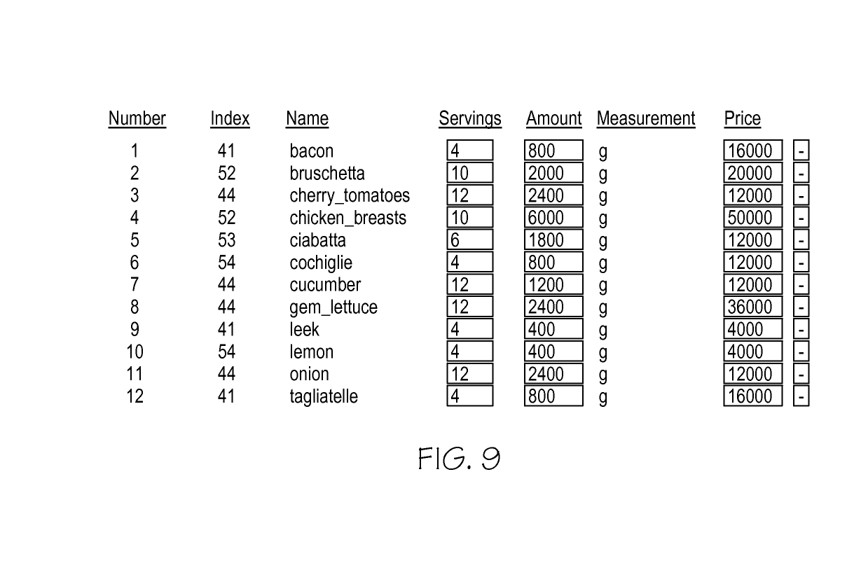

For example, as shown in FIG. 7, when the user selects a particular time period for creating a purchase order, the cooking list added in that particular time section is displayed. FIG. 8 depicts the cooking list associated with the selected time period. At this time, editing function capabilities (e.g., selecting or deleting a particular cooking menu in the list, adjusting servings, etc.) may be offered. The cooking ingredients included in FIG. 8 may be separated as main or side ingredients, as shown in FIGS. 9 and 10. The online shopping system may offer functions such as adjusting an ingredient amount. The system may also allow for deleting a particular ingredient when the user already possesses a sufficient amount of the ingredient.

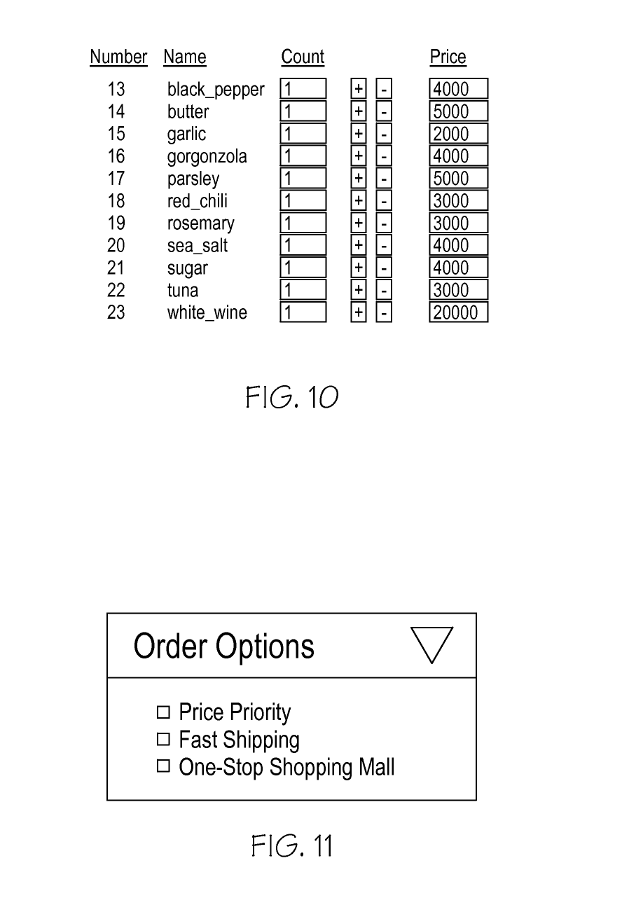

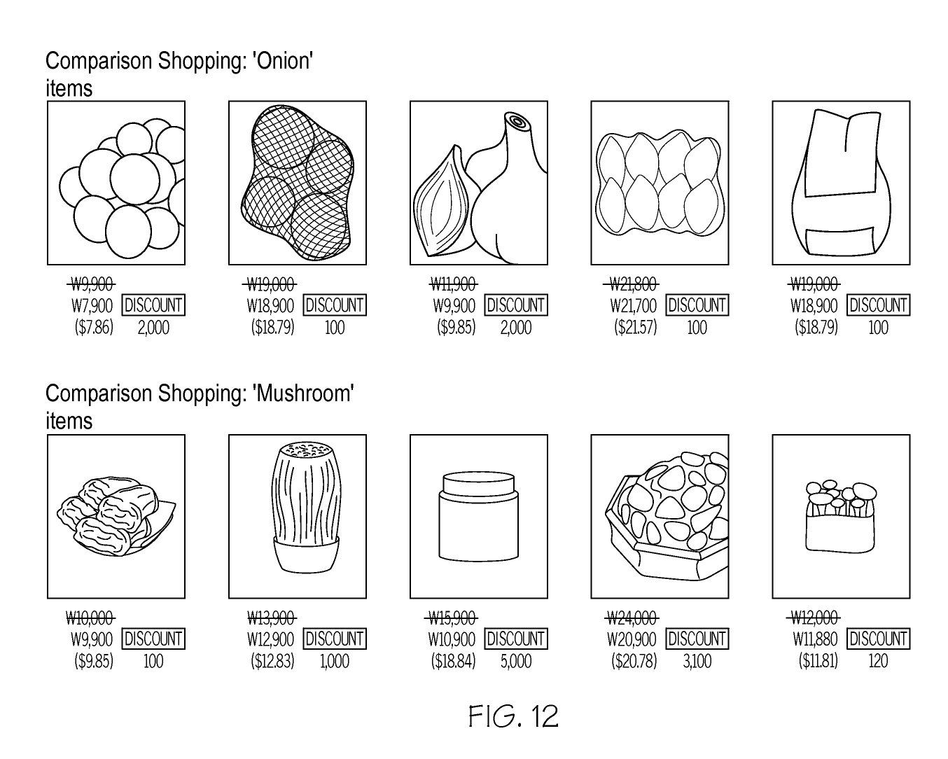

After user review, the user may select to order from a single online shopping mall or from multiple shopping malls based on a price comparison. The online shopping system may collect information from multiple online shopping malls and offer diverse ordering options. The online shopping system may also provide ‘order options’ such as price priority, fast shipping, or one-stop shopping mall, as shown in FIG. 11. For example, if a user selects ‘price priority’, the online shopping system may order the different ingredients from one or more shopping malls based strictly on providing the user the lowest price for each ingredient. The price priority option may collect information from any number of shopping malls, analyze prices of the ingredients for order, and recommend the shopping mall with the lowest prices, as shown in FIG. 12. As such, the user can select items of interest and is able to place orders from different shopping malls based on price.

If the user selects the ‘fast shipping’ option, the system may order from a shopping mall having the fastest shipping arrival time. This option is advantageous because the user can receive the order at a preferred time. If the user selects the ‘one-stop shopping mall’, the system may provide an order from the best shopping mall based on a combination of price and shipping arrival time. This option proves to be advantageous because both price and shipping time can be factored into the decision. After selecting an order option, the user may then place the order.

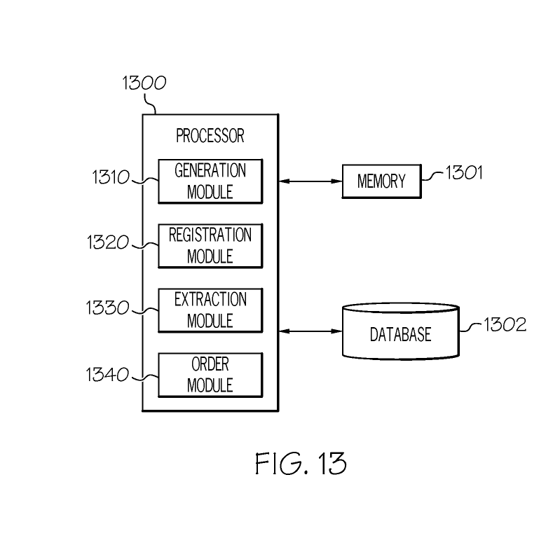

FIG. 13 depicts a block diagram of an online shipping system offering an interactive video-based online shopping service. As shown, the online shopping system includes processor 1300, memory 1301, and database 1302. Processor 1300 includes generation module 1310, registration module 1320, extraction module 1330, and order module 1340.

The interactive cooking video including the overlaid metadata pertaining to the ingredients may be stored in memory 1301. By this medium, program code for offering a service for purchasing ingredients by a user may be stored. The steps executed in the online shopping system, as described above, may be implemented by program code in memory 1301. Memory 1301 can include computer system readable media in the form of volatile memory, such as random access memory (RAM) and/or cache memory.

Database 1302 provides for storage and maintenance of all the information necessary to offer online shopping service, such as information pertaining to a cooking video, recipe information added by a recipe donor regarding the cooking video, information regarding a calendar associated with a user viewing the cooking video, and the like.

Processor 1300 processes based on the program code stored in memory 1301. Processor 1300 may include one or more microprocessors, including a central processing unit (CPU). As shown, processor 1300 may include generation module 1310, registration module 1320, extraction module 1330, and order module 1340.

Generation unit 1310 may generate an interactive cooking video by adding recipe information donated by a recipe donor to an existing cooking video. The recipe information may be overlaid or embedded into the cooking video as metadata. The generation unit 1310 may provide a video production tool for interacting with the cooking video. Using the video production tool, the generation unit 1310 may add recipe information received from the recipe donor as a virtual artifact when the cooking video is displayed on a display screen. The display screen may include a computer monitor, a tablet screen, a mobile phone screen, and any other type of display screen capable of rendering video. Each defined virtual artifact may be displayed at a specific frame or time of video display. The interactive cooking video may be stored in database 1302 and can be offered to viewers through diverse mediums such as websites. At this time, the metadata pertaining to the recipe information may be separately stored from video data. When the interactive cooking video is played on a display screen, the metadata is displayed as virtual artifacts.

The registration unit 1302, based on a request of a user viewing an interactive cooking video, may register the video with a web page associated with the user. To illustrate, the registration unit 1302 receives a frame (or frames) and the URI of the actual video which are added to a user calendar on the web page. When the user wishes to play the video, the URI is used to access the entire cooking video from the system offering the interactive videos. The frame (or frames) and the URI may be stored in database 1302. In one example, the frame (or frames) and the URI of the interactive cooking video may be added to the user's calendar through a ‘drag and drop’ method from a system offering interactive cooking videos to an interactive video-based online shopping system.

Recipe information is overlaid or embedded in the cooking video as metadata. In one example, the extraction unit 1330 may extract the recipe information including necessary ingredients from the metadata that is overlaid on the cooking video. In another example, the extraction unit 1330 may read the recipe information from a storage location. Subsequently, the extraction unit 1330 may separates information extracted from the recipe information into main and side ingredients and store that information in database 1302. In the recipe information, each ingredient necessary for cooking can be stored in a main ingredient or side ingredient basis. In addition or alternatively, information such as the name of ingredient and required ingredient amount may be stored in database 1302. The interactive cooking video may be shared through Social Networking Sites (SNS). Additionally, particular video frames, as well as comments and opinions about the recipe information, may be shared.

The order unit 1340 may connect different online shopping malls enabling a user to make a collective purchase order from at least one of the shopping malls. The order unit 1340 may provide a user interface environment for easy access to menu list, main ingredient list, and side ingredient list according to a specified time section. The order unit 1340 may allow a user to select time section when the menu is added, confirm an ingredient list of a dish added at a selected time, adjust portions of ingredients, process orders of selected ingredients, and the like. The order unit 1340 may receive user's order option and make a single, bundled purchase order of selected ingredients. At this time, the order unit 1340 collects information from various online shopping malls and provides diverse order options. As described above, the order unit 1340 may provide a price priority option, a fast shipping option, and a one-stop shopping mall option.

By adding recipe information received from a cooking video recipe donor as metadata, an interactive capable cooking video offering is made possible. When a user links a cooking video to the user's calendar, access to the particular video or image becomes convenient. Recipe information is automatically extracted from the cooking video. A user may confirm and/or adjust ingredients. The user may also, through connection with online shopping malls, collectively purchase ingredients included in the recipe information. A user's time and effort to search and order ingredients is minimized, making it simpler and convenient to order ingredients.

The embodiments of the invention may be implemented as a computer readable signal medium or storage device, which may include a propagated data signal with computer readable program code embodied therein (e.g., in baseband or as part of a carrier wave). Such a propagated signal may take any of a variety of forms including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium including, but not limited to, wireless, wireline, optical fiber cable, radio-frequency (RF), etc., or any suitable combination of the foregoing.

As used herein, it is understood that the terms “program code” and “computer program code” are synonymous and mean any expression, in any language, code, or notation, of a set of instructions intended to cause a computing device having an information processing capability to perform a particular function either directly or after either or both of the following: (a) conversion to another language, code, or notation; and/or (b) reproduction in a different material form. To this extent, program code can be embodied as one or more of: an application/software program, component software/a library of functions, an operating system, a basic device system/driver for a particular computing device, and the like.

A data processing system suitable for storing and/or executing program code can be provided hereunder and can include at least one processor communicatively coupled, directly or indirectly, to memory elements through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output and/or other external devices (including, but not limited to, keyboards, displays, pointing devices, etc.) can be coupled to the system either directly or through intervening device controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems, and Ethernet cards.

The foregoing description of various aspects of the invention has been presented for purposes of illustration and description. It is not intended to be exhaustive or to limit the invention to the precise form disclosed and, obviously, many modifications and variations are possible. Such modifications and variations that may be apparent to a person skilled in the art are intended to be included within the scope of the invention as defined by the accompanying claims.

Although presently preferred embodiments of the present invention have been described in detail herein above, it should be clearly understood that many variations and/or modifications of the basic inventive concepts herein taught, which may appear to those skilled in the pertinent art, will still fall within the spirit and scope of the present invention, as defined in the appended claims. Embodiments of the present invention are intended to be implemented with any video file related to any type of DIY project. For example, the DIY project may be related to home improvement or maintenance, car repair, or the like. The examples listed above are exemplary only and not intended to be limiting. Any type of DIY project may be presented in the interactive video file.

What is claimed is:

1. A method for online shopping, the method comprising the computer-implemented steps of:
overlaying metadata on a Do-It-Yourself (DIY) video file, wherein the metadata includes information associated with a set of materials used in the DIY video file;
registering the DIY video file with a web page;
playing the DIY video file from the web page;
extracting the information associated with the set of materials from the metadata when the DIY video file is played from the web page; and
connecting with at least one online shopping mall, wherein each online shopping mall includes at least one material in the set of materials for purchase.

2. The method of claim 1, wherein the web page includes a user calendar.

3. The method of claim 1, wherein the DIY video file is associated with food preparation.

4. The method of claim 3, wherein the set of materials is a set of food ingredients.

5. The method of claim 1, wherein the computer-implemented step of registering the DIY video file with a web page includes providing the web page with at least one frame and a Uniform Resource Identifier (URI) of the DIY video file.

6. The method of claim 5, further comprising the computer-implemented step of adding the at least one frame and the Uniform Resource Identifier (URI) of the DIY video file to the web page.

7. The method of claim 6, wherein the computer-implemented step of playing the DIY video file from the web page includes selecting the at least one frame and accessing the DIY video file using the URI of the DIY video file.

8. The method of claim 6, wherein the at least one frame and the URI of the DIY video file is added to the web page using a drag and drop method.

9. The method of claim 1, wherein the DIY video file is stored separately from the metadata.

10. The method of claim 1, wherein the metadata is displayed on the DIY video file as a virtual artifact.

11. The method of claim 1, wherein the metadata is stored in a single file format.

12. The method of claim 11, wherein the single file format includes at least one of eXtensible Markup Language (XML) format, JavaScript Object Notation (JSON) format, ontology format, or string format.

13. The method of claim of claim 4, further comprising the computer-implemented step of categorizing each ingredient in the set of ingredients.

14. The method of claim 13, wherein the computer-implemented step of categorizing each ingredient in the set of ingredients includes separating the set of ingredients into main and side ingredients.

15. The method of claim 14, wherein the set of ingredients are separated using at least one of a category, Jaccard coefficient method, or domain expert.

16. The method of claim 1, further comprising the computer-implemented step of purchasing at least one material from the set of materials from the at least one online shopping mall.

17. The method of claim 16, further comprising the computer-implemented step of providing a set of order options when purchasing at least one material from the set of materials from the at least one online shopping mall.

18. The method of claim 16, wherein the order options include at least one of price priority, fast shipping, or one-stop shopping mall.

19. A computer-readable storage medium storing computer instructions which, when executed, enables a computer system to provide online shopping, the computer instructions comprising:
overlaying metadata on a Do-It-Yourself (DIY) video file, wherein the metadata includes information associated with a set of materials used in the DIY video file;
registering the DIY video file with a web page;
playing the DIY video file from the web page;
extracting the information associated with the set of materials from the metadata when the DIY video file is played from the web page; and
connecting with at least one online shopping mall, wherein each online shopping mall includes at least one material in the set of materials for purchase.

20. A system for online shopping in a networked computing environment, comprising:
a memory medium comprising instructions;
a bus coupled to the memory medium; and
a processor coupled to the bus that when executing the instructions causes the system to:
overlay metadata on a Do-It-Yourself (DIY) video file, wherein the metadata includes information associated with a set of materials used in the DIY video file;
register the DIY video file with a web page;
play the DIY video file from the web page;
extract the information associated with the set of materials from the metadata when the DIY video file is played from the web page; and
connect with at least one online shopping mall, wherein each online shopping mall includes at least one material in the set of materials for purchase.
